(19) United States
(12) Patent Application Publication
(10) Pub. No.: US 2006/0120334 A1
(43) Pub. Date: Jun. 8, 2006

(54) Enhanced direct link transmission method and system for wireless local area networks

(75) Inventors: Hao-Li Wang, Taipei City (TW); Zi-Tsan Chou, Taipei City (TW)

Correspondence Address: BACON & THOMAS, PLLC, 625 SLATERS LANE, FOURTH FLOOR, ALEXANDRIA, VA, 22314, US

(73) Assignee: Institute For Information Industry, Taipei City (TW)

(21) Appl. No.: 11/028,519

(22) Filed: Jan. 5, 2005

(30) Foreign Application Priority Data
Nov. 23, 2004 (TW) 093135971

(51) Int. Cl. H04Q 7/24

(52) U.S. Cl. 370/338

(57) ABSTRACT

In a wireless local area network comprising an AP, and a first mobile station adapted to directly transmit data to a second mobile station, an enhanced direct link transmission method comprises causing the first mobile station to transmit an EDLP.request; (i) when the first and second mobile stations are adjacent, responsive to receiving the EDLP.request, the second mobile station replying an EDLP.response containing a result code indicating SUCCESS to the first mobile station in a first time or (ii) when they are not adjacent, causing the AP to reply an EDLP.response containing a result code indicating NOT_ADJACENT to the first mobile station in a second time if the second time is longer than the first time; and responsive to receiving the EDLP.response, the first mobile station transmitting a data frame to the second mobile station in the adjacent case or the AP in the non-adjacent case.

### BACKGROUND OF THE INVENTION

1. Field of the Invention

The present invention relates to the technical field of medium access control (MAC) layer in wireless networks and, more particularly, to an enhanced direct link transmission method and system for wireless local area networks.

2. Description of Related Art

Currently, IEEE 802.11 Standard is the most popular MAC protocol for wireless local area networks (WLANs). Based on the specifications of IEEE 802.11, data frame transmission between any two mobile stations (e.g., cellular phones, PDAs, notebooks, or other devices with wireless communication capability) under an infrastructure WLAN is performed via access point (AP) as shown in FIG. 1(a). Mobile station X performs distributed coordination function (DCF) of IEEE 802.11 to transmit data frame to AP, and in turn, AP performs DCF to transmit the data frame to mobile station Y. Two data frame transmission methods in IEEE 802.11 DCF, e.g. basic method and RTS/CTS method, are explained as follows.

In the basic method, it is assumed that mobile station X desires to transmit data to AP. Prior to transmitting a data frame, mobile station X must sense other transmission. Typically, it is necessary to wait a period of time consisting of DCF inter frame space (DIFS) period and a random number of backoff time slots. Mobile station X will transmit data frame to AP if there is no data frame transmission at the end of the above waiting time (DCF+backoff slots). After receiving the data frame, AP will wait short inter frame space (SIFS) time prior to transmitting an acknowledgement (ACK) to mobile station X.

In the RTS/CTS method, it is assumed that mobile station X desires to transmit data to AP. Prior to transmitting a data frame, mobile station X must detect whether any other mobile station is transmitting data frame. Typically, it is necessary to wait a period of time consisting of DIFS time and a randomly selected backoff slot time. Mobile station X will transmit a request to send (RTS) to AP if there is no data frame transmission at the end of the above waiting time (DCF+backoff slots). After receiving the RTS, AP will wait SIFS time prior to transmitting a clear to send (CTS) to mobile station X. After receiving the CTS, mobile station X will transmit data frame to AP after the SIFS time has elapsed. After receiving the data frame, AP will transmit ACK to mobile station X. The RTS/CTS method is designed to solve the hidden terminal problem.

As shown in FIG. 2, mobile station X transmits a data frame to mobile station Y via two stages. In the first stage, mobile station X transmits data frame to AP. In the second stage, AP transmits the data frame to mobile station Y. The DCF method is performed in each stage. In FIG. 2, it is shown that mobile station X performs the DCF method to transmit data frame to AP and AP performs the DCF method to transmit the same to mobile station Y. It is seen that steps including two times of contention and eight handshakes are performed in the process of transmitting data frame from mobile station X to mobile station Y. In a carrier sense multiple access with collision avoidance (CDMA/CA) based WLAN, more contention means more collision. As a result, throughput of the WLAN is decreased significantly.

In IEEE 802.11e draft (IEEE 802.11e/D6.0, Draft Supplement to Part II: Wireless medium access control (MAC) and physical layer (PHY) specifications: MAC enhancements for quality of service (QoS), IEEE, November 2003), a modification to the original 802.11 is proposed in which a mobile station is allowed to directly transmit data frame to any other mobile station by AP if the AP exists in the WLAN as shown in FIG. 1(b). Such technique is known as direct link protocol (DLP).

FIG. 3 illustrates DLP operation. First, mobile station X (source terminal) transmits a direct link protocol request (DLP.request) to AP. Next, AP transmits the same to mobile station Y (destination terminal). Mobile station Y will acknowledge by transmitting a direct link protocol response (DLP.response) to AP if mobile station Y receives it. The DLP.response contains result code: SUCCESS. In response to receiving the DLP.response, AP will transmit it to mobile station X. Both the DLP.request and DLP.response contain information (e.g., MAC address of mobile station, supported rates, safety, etc.) related to mobile stations X and Y. After exchanging the DLP.request and DLP.response, mobile station X can directly transmit data frame to mobile station Y without being via AP.

In view of the DLP method employed by the above 802.11 specifications and 802.11e draft, it is found that AP is required in their operations. As such, the times of exchanging control frames increase, resulting in a decrease of throughput of the WLAN. Moreover, if AP is out of order, mobile stations X and Y cannot exchange data frame even though they are adjacent to each other (i.e., they can receive signals from each other). Thus, it is desirable to lower the possibility of AP intervention as experienced in prior 802.11 specifications and 802.11e draft, decrease the time of exchanging data frame, carry out a direct link between two mobile stations, and comply with existing IEEE 802.11 specifications.

### SUMMARY OF THE INVENTION

The object of the present invention is to provide an enhanced direct link transmission method and system for wireless local area networks, so as to lower the possibility of AP intervention, decrease the time of exchanging data frame, and carry out a direct link between two mobile stations.

One aspect of the present invention is to provide an enhanced direct link transmission method for wireless local area networks. The wireless local area network comprises an access point (AP), a first mobile station and a second mobile station. The first mobile station is adapted to directly transmit data to the second mobile station. When the first mobile station is adjacent to the second mobile station, the method comprises the steps of: (A) causing the first mobile station to transmit an EDLP.request; (B) responsive to receiving the EDLP.request, the second mobile station replying an EDLP.response containing a result code indicating SUCCESS to the first mobile station in a first period of time; and (C) responsive to receiving the EDLP.response, the first mobile station transmitting a data frame to the second mobile station.

Another aspect of the present invention is to provide an enhanced direct link transmission method for wireless local area networks. The wireless local area network comprises an access point (AP), a first mobile station and a second mobile station. The first mobile station is adapted to directly transmit data to the second mobile station. When the first mobile station is adjacent to the second mobile station, the method comprises the steps of: (A) causing the first mobile station to transmit an EDLP.request; (B) causing the AP to reply an EDLP.response containing a result code indicating NOT_ADJACENT to the first mobile station in a second period of time if the second period of time is longer than the first period of time; and (C) responsive to receiving the EDLP.response, the first mobile station transmitting a data frame to the AP.

Other objects, advantages, and novel features of the invention will become more apparent from the detailed description when taken in conjunction with the accompanying drawings.

### BRIEF DESCRIPTION OF THE DRAWINGS

FIG. 1(a) depicts data frame transmission between two mobile stations via AP in prior art;

FIG. 1(b) depicts a direct data frame transmission between two mobile stations in prior art;

FIG. 2 depicts mobile station X performing a DCF method to transmit data frame to AP, and AP performing the DCF method to transmit the same to mobile station Y in prior art;

FIG. 3 depicts a DLP operation proposed by IEEE 802.11e draft;

FIG. 4a depicts an EDLP operation between adjacent mobile stations X and Y according to the invention;

FIG. 4b depicts the EDLP operation between non-adjacent mobile stations X and Y according to the invention;

FIGS. 5a, 5b, and 5c depict operations of transmitting data from mobile station X to mobile station Y as proposed by IEEE 802.11, DLP in IEEE 802.11e draft, and the EDLP according to the invention respectively; and

FIG. 6 plots throughput versus normalized traffic load for IEEE 802.11, DLP in IEEE 802.11e draft, and the EDLP according to the invention as comparison.

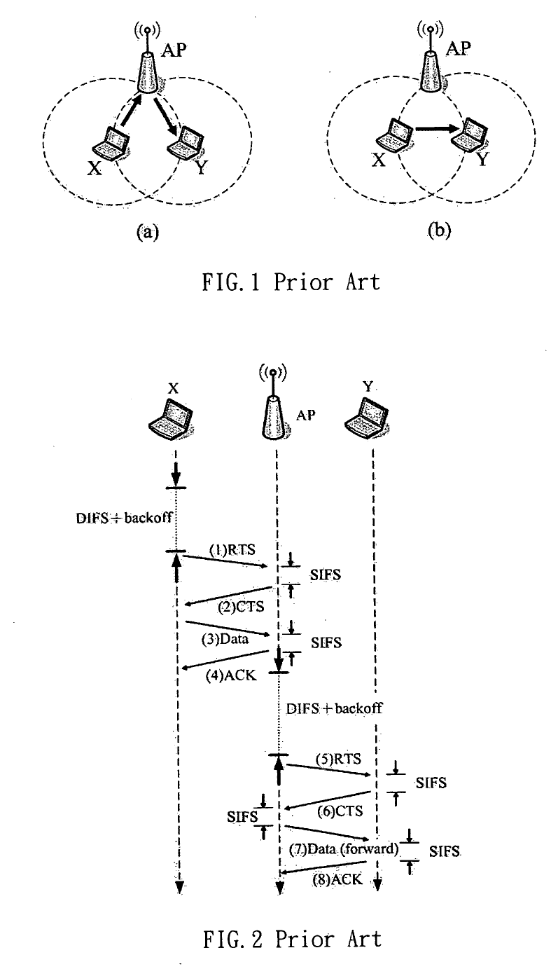

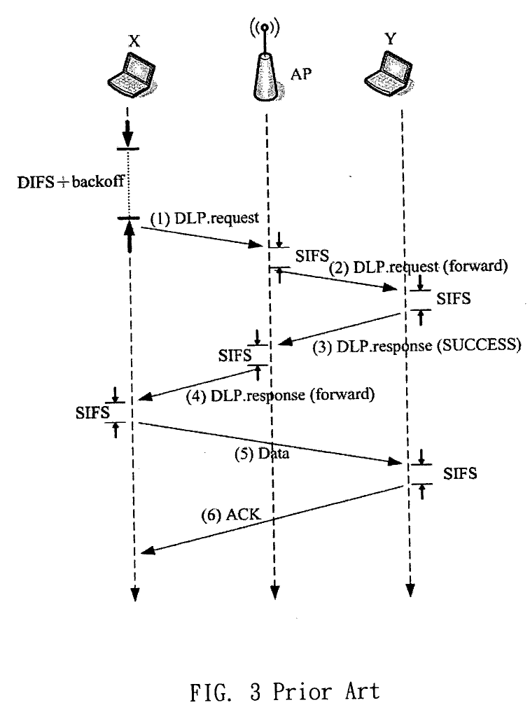

### DETAILED DESCRIPTION OF THE PREFERRED EMBODIMENT

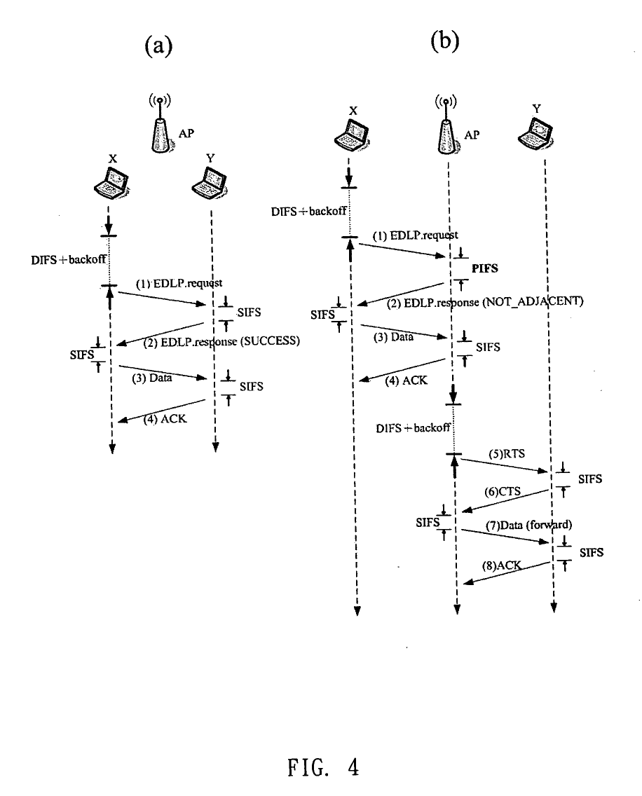

The system and method of the invention are embodied in IEEE 802.11 WLAN in which an enhanced direct link protocol (EDLP) is employed for facilitating data transfer between two mobile stations. Following is a detailed description of the EDLP operation. In FIG. 4(a), two adjacent mobile stations X and Y are within a service area of AP. The term adjacent means that mobile station X is able to receive signals from mobile station Y and vice versa. In FIG. 4(b), mobile stations X and Y are not adjacent.

In FIG. 4(a), mobile station X (source terminal) desires to transmit data to mobile station Y (destination terminal). Thus, mobile station X transmits an enhanced direct link protocol request (EDLP.request) to AP. Also, mobile station Y is able to receive the EDLP.request since mobile station Y is adjacent to mobile station X. In response to receiving the EDLP.request, AP replies an enhanced direct link protocol response (EDLP.response) in PCF inter frame space (PIFS) time. In response to receiving the EDLP.request, mobile station Y replies an EDLP.response in SIFS time. Based on IEEE 802.11, DIFS is larger than PIFS and PIFS is larger than SIFS. In response to receiving the EDLP.request from mobile station X, mobile station Y replies an EDLP.response including result code: SUCCESS in SIFS time. The mobile station Y (destination terminal) has a priority higher than AP for transmitting the EDLP.response since SIFS<PIFS. Also, AP can receive the EDLP.response including result code: SUCCESS sent from mobile station Y. As such, AP is aware that mobile station Y has replied the EDLP.request sent from mobile station X. Thus, AP will not respond. After receiving the EDLP.response including result code: SUCCESS, mobile station X transmits data frame to mobile station Y. In response to receiving the data frame, mobile station Y replies an ACK to mobile station X. As a result, a direct data link between two mobile stations is realized.

The EDLP.request contains information such as MAC address of mobile stations X and Y, ID (e.g., association ID (AID), MAC address, or any other codes for identifying purpose) of AP, supported rates, security, etc. The EDLP.response contains information such as result code or status code, MAC address of mobile stations X and Y, ID (e.g., AID, MAC address, or any other codes for identifying purpose) of AP, supported rates, security, etc. Thus, mobile station X or AP can respond based on the result code in the EDLP.response.

In FIG. 4(b), the EDLP operation between non-adjacent mobile stations X and Y is illustrated. Mobile station Y will not respond because it is not aware that mobile station X has transmitted the EDLP.request to AP. AP will reply an EDLP.response having a result code: NOT_ADJACENT to mobile station X after a PIFS time has elapsed if mobile station Y is an association member of AP. Thus, mobile station X is aware that it is not adjacent mobile station Y. Mobile station X will transmit data frame to AP after an SIFS time has elapsed. In response to receiving the data frame from mobile station X, AP performs a DCF method to transmit data frame to mobile station Y.

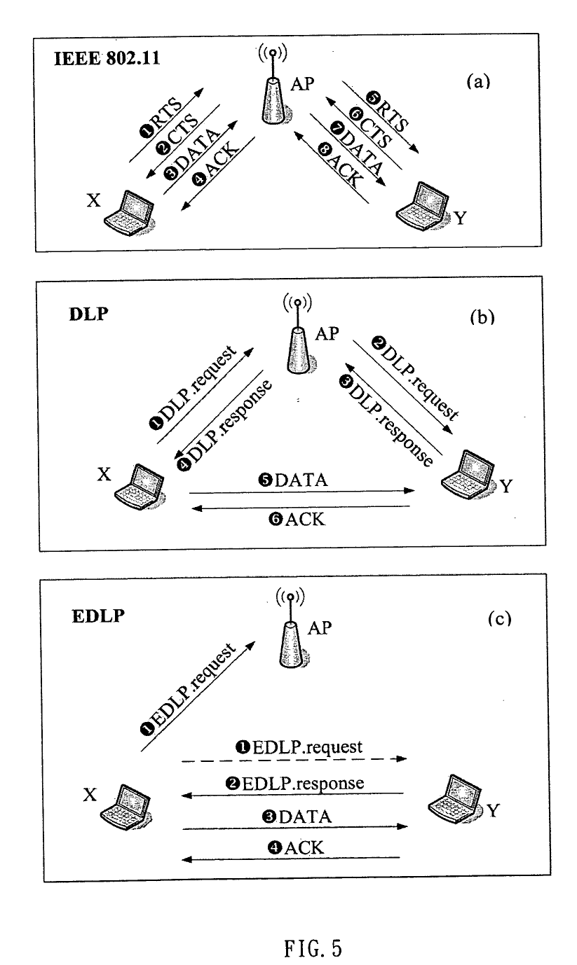

With reference to FIGS. 5(a), 5(b), and 5(c), operations of transmitting data from mobile station X to mobile station Y as proposed by IEEE 802.11, DLP in IEEE 802.11e draft, and EDLP according to the invention are respectively shown. Note that time interval between data frames is omitted. It is seen that two times of DCF contention and eight times of data transmission are performed by IEEE 802.11, one time of DCF contention and six times of data transmission are performed by DLP in IEEE 802.11e draft, and one time of DCF contention and four times of data transmission are performed by EDLP of the invention. Therefore, EDLP of the invention can achieve direct data transfer by a minimum number of data frames. As a result, advantages such as less time for data transmission and less chance of contention and collision can be obtained.

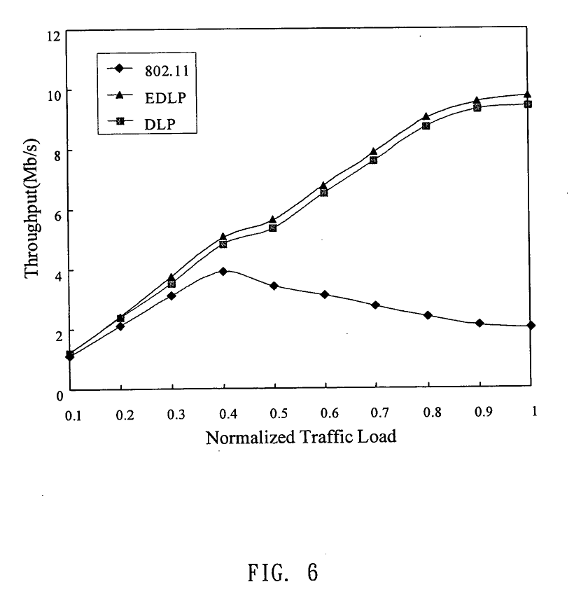

With reference to FIG. 6, it plots throughput versus normalized traffic load in the range of 0.1 to 1 in a physical layer having a data transfer rate of 11 Mbps for IEEE 802.11, DLP in IEEE 802.11e draft, and EDLP according to the invention. From the comparison, it is found that the DLP in IEEE 802.11e draft has a significant increase of throughput with respect to IEEE 802.11. Also, the EDLP according to the invention does not create an AP overhead and has less end-to-end delay. Thus, throughput of the EDLP according to the invention is higher than that of the DLP in IEEE 802.11e draft.

While the invention herein disclosed has been described by means of specific embodiments, numerous modifications and variations could be made thereto by those skilled in the art without departing from the scope and spirit of the invention set forth in the claims.

What is claimed is:

1. An enhanced direct link transmission method for wireless local area networks, the wireless local area network comprising an access point (AP), a first mobile station and a second mobile station, the first mobile station being adapted to directly transmit data to the second mobile station, the first mobile station being adjacent to the second mobile station, the method comprising the steps of:
(A) causing the first mobile station to transmit an enhanced direct link protocol request (EDLP.request);
(B) responsive to receiving the EDLP.request, the second mobile station replying an enhanced direct link protocol response (EDLP.response) to the first mobile station in a first period of time; and
(C) responsive to receiving the EDLP.response, the first mobile station transmitting a data frame to the second mobile station.

2. The method of claim 1, further comprising the step of:
(D) responsive to receiving the data frame, the second mobile station replies an acknowledge (ACK) to the first mobile station.

3. The method of claim 1, wherein the EDLP.request comprises IDs of the first and second mobile stations, an ID of AP, supported rates, and security information, and wherein the IDs are association IDs (AIDs), MAC addresses, or any other identifying codes.

4. The method of claim 1, wherein the EDLP.response comprises IDs of the first and second mobile stations, result code or status code, supported rates, and security information, and wherein the IDs are AIDs, MAC addresses, or any other identifying code.

5. The method of claim 1, wherein the first period of time is SIFS time defined by IEEE 802.11 specifications.

6. The method of claim 1, wherein the EDLP.response in the step (b) or (C) comprises a result code indicating SUCCESS.

7. An enhanced direct link transmission method for wireless local area networks, the wireless local area network comprising an access point (AP), a first mobile station and a second mobile station, the first mobile station being adapted to directly transmit data to the second mobile station, the first mobile station being adjacent to the second mobile station, the method comprising the steps of:
(A) causing the first mobile station to transmit an enhanced direct link protocol request (EDLP.request);
(B) causing the AP to reply an enhanced direct link protocol response (EDLP.response) to the first mobile station in a second period of time wherein the EDLP.response comprises a result code indicating NOT_ADJACENT if the second period of time is longer than the first period of time according to claim 1; and
(C) responsive to receiving the EDLP.response, the first mobile station transmitting a data frame to the AP.

8. The method of claim 7, further comprising the step of
(D) responsive to receiving the data frame, the AP replies an ACK to the first mobile station.

9. The method of claim 7, further comprising the step of
(E) causing the AP to transmit the data frame to the second mobile station in response to the result code indicating NOT_ADJACENT.

10. The method of claim 7, wherein the second period of time is PIFS time defined by IEEE 802.11 specifications.
